(19) United States
(12) Patent Application Publication
(10) Pub. No.: US 2025/0383849 A1
(43) Pub. Date: Dec. 18, 2025

(54) METHOD AND APPARATUS FOR PERFORMING CONTROL FLOW ATTESTATION

(71) Applicant: NEC Laboratories Europe GmbH, Heidelberg (DE)

(72) Inventor: Felix KLAEDTKE, Heidelberg (DE)

(21) Appl. No.: 19/107,601

(22) PCT Filed: May 5, 2023
(86) PCT No.: PCT/EP2023/062003

§ 371 Date: Feb. 28, 2025

(30) Foreign Application Priority Data
Dec. 21, 2022 (EP) 22215530

(51) Int. Cl. G06F 8/41

(52) U.S. Cl. CPC G06F 8/433

(57) ABSTRACT

A method of performing control flow attestation includes constructing a control flow graph (CFG) of a program whose execution by a prover is to be attested. The CFG is decomposed into a directed acyclic subgraph (DAG). Nodes of the DAG are annotated bottom-up with hashes and the hashes of root nodes of the nodes of the DAG are installed at a measurement database of a verifier. A collector, during program execution, receives information from the prover about the nodes of the DAG along the program execution, the information including the hashes of the nodes. The collector generates program execution measurements by computing, based on the information received from the prover, for each execution segment of the DAG, the hash of the corresponding root node of the execution segment and sends the generated program execution measurements comprising the computed hashes of the root nodes to the verifier.

### CROSS REFERENCE TO RELATED APPLICATIONS

This application is a U.S. National Phase application under 35 U.S.C. § 371 of International Application No. PCT/EP2023/062003, filed on May 5, 2023, and claims benefit to European Patent Application No. 22215530.1, filed on Dec. 21, 2022. The International Application was published in English on Jun. 27, 2024 as WO 2024/132230 A1 under PCT Article 21(2).

### STATEMENT REGARDING SPONSORED RESEARCH OR DEVELOPMENT

The project leading to this application has received funding from the European Union's Horizon 2020 research and innovation programme under grant agreement No 957406.

### FIELD

The present invention relates to a method, apparatus and computer-readable medium for performing control flow attestation.

### BACKGROUND

Remote attestation is a cornerstone for building trustworthy systems and services. In a nutshell, a trusted entity—also often called the verifier—obtains state or behavioral information about a remote entity—also often called the prover. The remote entity is, e.g., a device or a critical software component of a service. The obtained information allows the verifier to check the remote entity's integrity. In particular, in cloud computing applications and IoT deployments, such integrity checks are essential since the remote entity's environment is usually untrusted. A compromised operating system could, for example, tamper with the software of the service, either at its installation or during its runtime. The verifier's checks would reveal any deviation from the prover's expected state or behavior, and appropriate countermeasures could be taken like terminating the component.

Static attestation methods are widely used in cloud computing and provide guarantees that a software is correctly installed. For instance, when running the software of a critical service component inside a trusted execution environment (TEE) like an enclave in Intel SGX, which protects the software and its data from any other process on an untrusted host machine, the remote entity checks that the corresponding TEE has been properly set up. Setting up the TEE is usually done by the operating system. As noted above, a malicious operating system could wrongly configure the TEE, e.g., by modifying the software when it is loaded into the TEE. However, when attesting the initial TEE state, the verifier would detect such malicious activities from the operating system. Consequently, since the attestation failed, no sensitive data would be loaded into the TEE and the TEE would be removed.

In contrast to static attestation methods, dynamic attestation methods—as described, e.g., in C. Kil, E. Sezer, A. Azab, P. Ning, and X. Zhang: “Remote Attestation to Dynamic System Properties: Towards Providing Complete System Integrity Evidence”, in Proceedings of the IEEE/IFIP International Conference on Dependable Systems & Networks (DNS), IEEE, 2009, available online: https://doi.org/10.1109/DSN.2009.5270348, or in L. Davi, A.-R. Sadeghi, and M. Winandy: “Dynamic Integrity Measurement and Attestation: Towards Defense against Return-Oriented Programming Attacks”, in Proceedings of the ACM Workshop on Scalable Trusted Computing (STC), ACM Press, 2009, available online: https://doi.org/10.1145/1655108.1655117—aim at attesting whether a program executes as intended. That is, while the software is running, the verifier checks that nobody tampered with the execution. It should be noted that even if the software is correctly installed—possibly attested prior to its execution—and protected by a TEE, an attacker may be able to exploit a software bug, e.g., a buffer overflow to execute malicious code inside the TEE.

Sophisticated attacks may not even require to inject new code but use code fragments of the installed software, cf. return-oriented programming as described in H. Shacham: “The Geometry of Innocent Flesh on the Bone: Return-into-libc without Function Calls (on the x86)”, in Proceedings of the 14^{th} ACM Conference on Computer and Communications Security (CCS), ACM Press, 2007, available online: https://dl.acm.org/doi/10.1145/1315245.1315313). Common to such kind of attacks is that they change the program's control flow. Hence, dynamic attestation methods often use the program's control flow graph (CFG) as a basis to check whether the actual execution deviates from the expected execution of the program, for reference, see, e.g., T. Abera et al.: “C-FLAT: Control-Flow Attestation for Embedded Systems Software”, in Proceedings of the 2016 ACM SIGSAC Conference on Computer and Communications Security (CCS), ACM Press, 2016, available online: https://dl.acm.org/doi/10.1145/2976749.2978358, M. Morbitzer et al.: “GuaranTEE: Introducing Control-Flow Attestation for Trusted Execution Environments”, arXiv.org, 2022, available online: https://doi.org/10.48550/arXiv.2202.07380, I. De Olivera Nunes, S. Jakkamsetti, and G. Tsudik: “Tiny-CFA: Minimalistic Control-Flow Attestation Using Verified Proofs of Execution”, in Proceedings of the 2021 Design, Automation & Test in Europe Conference & Exhibition (DATE), IEEE, 2021, available online: https://doi.org/10.48550/arXiv.2011.07400, F. Toffalini et al.: “ScaRR: Scalable Runtime Remote Attestation for Complex Systems”, in Proceedings of the 22^{nd} International Symposium on Research in Attacks, Intrusions and Defenses (RAID), Usenix, 2019, available online: https://www.usenix.org/system/files/raid2019-toffalini.pdf), or M. Conti, E. Dushku, and L. V. Mancini: “RADIS: Remote attestation if distributed IoT services”, in Proceedings of the 6^{th} International Conference on Software defined Systems (SDS), IEEE, 2019, available online: https://doi.org/10.1109/SDS.2019.8768670).

Current CFG attestation methods, however, do not scale well in the program size. In fact, they are limited to programs of fairly small size with limited functionality, for reference, see the above mentioned references by T. Abera et al. and by M. Morbitzer et al. First, it is pointed out that in these methods, the measurements for different executions differ. Second, it is noted that the verifier uses a database to check whether a measurement obtained from the prover corresponds to a valid execution. The measurements in the verifier's database are obtained in an offline phase from the program's CFG, which, even when the graph has no cycles, has in the worst-case exponentially many maximal paths. In summary, the size of the verifier's database is in the worst case exponential in the program size.

To partially overcome this burden in practice, various strategies have been used to reduce the database. For instance, nodes in the CFG of a program fragment like the nodes of a procedure are merged to a single node, execution segments instead of complete executions are measured and checked individually, and only the executions paths that are considered as critical and vulnerable are checked. However, none of these strategies lowers the worst case size of the verifier's database.

### SUMMARY

In an embodiment, the present disclosure provides a method of performing control flow attestation. In the method, a control flow graph (CFG) of a program whose execution by a prover is to be attested is constructed. The CFG is decomposed into a directed acyclic subgraph (DAG). Nodes of the DAG are annotated bottom-up with hashes and the hashes of root nodes of the nodes of the DAG are installed at a measurement database of a verifier. A collector, during program execution, receives information from the prover about the nodes of the DAG along the program execution, the information including the hashes of the nodes. The collector generates program execution measurements by computing, based on the information received from the prover, for each execution segment of the DAG, the hash of the corresponding root node of the execution segment and sends the generated program execution measurements comprising the computed hashes of the root nodes to the verifier.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating a system model in accordance with an embodiment of the present disclosure;

FIG. 2 illustrates an example of a control flow graph in accordance with an embodiment of the present disclosure;

FIG. 3 illustrates an example of a topological sorted graph (left) and an acyclic subgraph with back edge, leave, and roots (right) in accordance with an embodiment of the present disclosure;

FIG. 4 illustrates a process of bottom-up annotation in accordance with an embodiment of the present disclosure;

FIG. 5 illustrates a process of hash annotations of CFG nodes in accordance with an embodiment of the present disclosure;

FIG. 6 is a diagram illustrating a process of bottom-up measurement computation for a segment of a directed acyclic graph in accordance with an embodiment of the present disclosure;

FIG. 7 is a diagram illustrating a control workflow executed by a verifier in accordance with an embodiment of the present disclosure;

FIG. 8 is a diagram illustrating a control workflow executed by a collector in accordance with an embodiment of the present disclosure;

FIG. 9 is a diagram illustrating a measurement computation workflow executed by a collector in accordance with an embodiment of the present disclosure;

FIG. 10 is a diagram illustrating an alternative measurement computation workflow executed by a collector in accordance with an embodiment of the present disclosure;

FIG. 11 is a diagram illustrating a mechanism of function calls and returns in a program execution in accordance with an embodiment of the present disclosure; and

FIG. 12 is a diagram illustrating a process of bottom-up measurement computation in accordance with an embodiment of the present disclosure.

### DETAILED DESCRIPTION

Embodiments of the present disclosure provide an improved concept for performing control flow attestation, in which the verifier's measurement database is reduced. According to a first aspect of the present disclosure, this is achieved by a method of performing control flow attestation, the method comprising: constructing a control flow graph, CFG, of a program whose execution by a prover is to be attested; decomposing the CFG into a directed acyclic subgraph, DAG; annotating the nodes of the DAG bottom-up with hashes and installing the hashes of the root nodes of the DAG at a measurement database of a verifier; receiving, by a collector during program execution, information from the prover about the nodes of the DAG along the program's execution, the information including the hashes of the nodes; and generating, by the collector, program execution measurements by computing, based on the information received from the prover, for each execution segment of the DAG the hash of the execution segment's root node and sending the generated program execution measurements including the computed root node hashes to the verifier.

Another aspect relates to an apparatus for performing control flow attestation, the apparatus comprising one or more processors configured, alone or in combination, to carry out at least parts of the above method.

Another aspect relates to a corresponding non-transitory computer-readable medium comprising instructions which, when executed by a computer, cause the computer to carry out at least parts of the above method.

According to an embodiment, the present disclosure provides a method for measuring and checking program executions against the program's control flow. The method comprises an offline phase and an online phase. During the offline phase, a control flow graph is constructed for the program, provided by the prover, to be tested. The control flow graph is decomposed into directed acyclic subgraphs and the nodes are annotated bottom-up with hash values. The hashes of the root nodes are installed in the verifier database. Further, for obtaining information about the execution of the program, the program is instrumented and the information is stored in the collector. During the online phase, the prover executes the instrumented program and sends information about its execution to the collector. The collector creates measurements from the information it receives from the prover. The verifier obtains measurements about execution and checks their correctness by its database. Specifically, the verifier may check the correctness of the received root node hashes based on the root node hashes installed at the verifier's measurement database. It is noted that with the information that the verifier receives from the prover (online phase) together with the database (offline phase), the verifier has the “ingredients” to check whether the program was properly executed. In this respect, these two parts already attest a proper program execution. However, the check performed by the verifier serves as a tool for the verifier to convince itself that the prover executed the program properly.

According to an embodiment, the sending of the generated program execution measurements including the computed root node hashes to the verifier may be performed only after successful authentication of the verifier, e.g. after the prover has successfully executed a challenge-response authentication with the verifier.

Embodiments of the proposed method are based on remote checks of whether program executions deviate from expected program behavior. Such checks are used, e.g., in cloud computing, where programs are executed on untrusted nodes. In particular, with these checks one can detect compromised software components and secure the applications at runtime. The embodiments of the presented method exponentially improve over existing remote attestation methods for program executions. For example, the embodiments include a dynamic attestation method that reduces the size of the verifier's measurement database. Namely, in the offline phase, the database can be constructed linear in time and space with regard to the size of the given program. Furthermore, in the online phase, the overhead in obtaining the measurement of an execution of the program is moderate. Namely, as in the previous methods, the overhead is linear in the length of the program execution. Embodiments of the present disclosure provide a heuristic to reduce this overhead during program execution by caching and reusing previously computed partial measurements.

Prior control flow attestation approaches require to construct in a preprocessing step a measurement database for the verifier that comprises all of valid program executions. This step is expensive. Even for simple (small) programs, such a database can be huge, as the number of valid program executions can grow exponentially with the number of program locations. In contrast, in accordance with the embodiments of the present disclosure, the verifier's database must only be populated with measurements linear in the number of program locations. Even more importantly, this database can be constructed in linear time in the size of the program. Overall, the method disclosed herein significantly reduces the complexity (time and space) of the preprocessing step in control flow attestation. Thus, the embodiments have the potential to make control flow attestation scalable. It should be noted that the overhead during program execution remains linear in the length of the program execution.

The embodiments of the present disclosure may help securing data sensitive services, e.g. in IoT or cloud deployments, by checking the execution of their critical software components. Note that remote attestation for enclaves only checks at the start that the intended software is installed prior to their execution. After installment, an attacker can exploit, e.g., buffer overflows to tamper with the software. Control low attestation targets the detection of software tampering during program execution. Hence, control flow attestation in combination with static remote attestation provides higher security guarantees.

In the embodiments of the present disclosure, the overhead in collecting the hashes during the execution in a program may be significant and may thus increase the program's running times. However, this overhead can be reduced, e.g., by only attesting the execution of critical program parts. Generally, it should be noted that this overhead seems inherit to control flow attestation, as experiments of prior work suggest, see, e.g., the above referenced documents by T. Abera et al. and M. Morbitzer et al. Further, it is worth noting that the combination of the collected hashes during program execution and the verification of the measurements also results in an overhead. However, according to embodiments it may be provided that both the combination and the verification are carried out in parallel. For example, the program can be executed on a CPU core different from the CPU core on which the hashes are combined.

In an embodiment, the method comprises an offline phase that is carried out prior to the program execution. In this offline phase, the program is modified by providing the program with the hashes of the nodes of the DAG and the program is instrumented to communicate, whenever a node is entered, the node's hash to the collector. The program modifications may be performed by a trusted entity either before program deployment or at program load time, e.g., by a trusted boot loader.

In an embodiment, the program instrumentation is performed in such a way that the collector obtains from the prover a unique identifier of each visited node. Additionally, the collector may obtain at least one of the following information items:
a Boolean value indicative of whether the visited node is a leaf in the DAG,
a list of the identifiers with the parents of the visited node for which the back edge has been deleted in the DAG,
a list of hashes of the node's children nodes when exiting the node.

According to an embodiment, the verifier may be configured to execute, prior to program execution, a static remote attestation method to ensure that the instrumented program has been correctly loaded into a memory of the prover's machine.

In an embodiment, the collector is run as a trusted kernel module of the of prover's machine.

In an embodiment, the control flow graph may be decomposed into the DAG by computing a feedback vertex set, FVS, and by removing the outgoing edges of the nodes in the computed FVS. Alternatively, the control flow graph may be decomposed into the DAG by computing a feedback arc set, FAS, and by removing individual edges of the nodes in the computed FAS.

In an embodiment, the program execution measurements may be handed over to the verifier in batches. In certain cases, in particular, when the segments are short, this can be more efficient than sending the measurement of each segment separately to the verifier. Alternatively or additionally, it may be provided that program execution measurements computed for two or more execution segments of the DAG are combined into a single program execution measurement. However, in such case, the offline phase has to be adapted accordingly, i.e. the combined measurement has to be included in the verifier's measurement database.

In an embodiment, the step of checking, by the verifier, the correctness of the received root node hashes based on the root node hashes installed at the verifier's measurement database is performed instantly based on program execution measurements handed over to the verifier during program execution. Alternatively, this step may be executed as a post processing step after program execution based on logged program execution measurements.

In an embodiment, and may be provided that previous measurements of execution segments are stored in a cache memory of the collector, which can then be reused by the collector from the cache memory when the program runs again through a respective execution segment or suffix of execution segment, instead of recomputing it again from scratch.

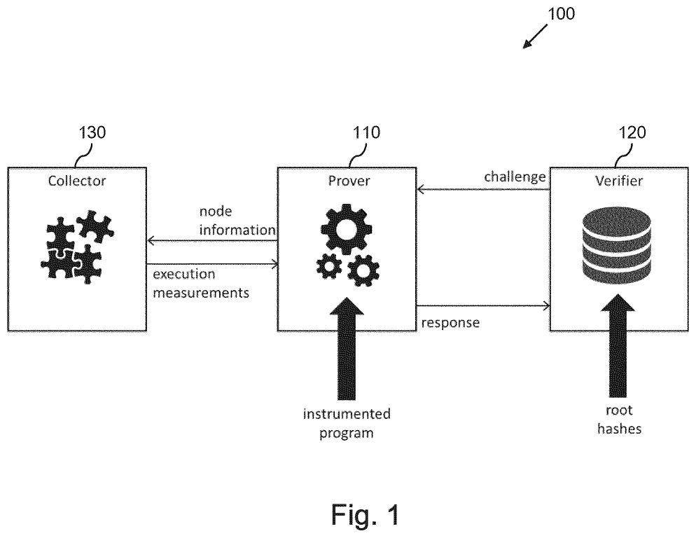

FIG. 1 provides an overview of a system model 100 according to an embodiment of the present disclosure. In the following, first, the underlying system model 100 is described and background is provided. Then, the two phases of a dynamic attestation method according to embodiments of the present disclosure are described. A first phase analyzes a given program and instruments the program to extract information during its executions. The second phase measures program executions and checks program behavior.

### System Model

As shown in FIG. 1, the underlying system model 100 includes a prover 110, a verifier 120 and a collector 130. The prover 110 executes a given application module for which the verifier 120 wants to attest that the application executes according to its instructions, e.g., its control flow. The application module may be either an entire program or parts thereof such as specific, critical functions of the respective application. Typically, the prover 110 and the verifier 120 are running on different machines. That is, the verifier 120 wants to attest remotely the correct execution of the application. In particular, the verifier 120 is running in a safe environment and is trusted. In contrast, the prover's 110 environment is untrusted. Details of a possible attacker model are described below.

According to an embodiment, the communication between the prover 110 (or the collector 130, respectively) and the verifier 110 may be secured, for instance based on a challenge-response-protocol. To this end, challenge-response messages may be exchanged between the prover 110 and the verifier 120, as indicated in FIG. 1. Essentially, the first message (challenge, sent from the verifier 120 to the prover 110) may be a request for an operation and the second message (response, sent from the prover 110 to the verifier 120) may contain the answer/result to the request. In this context, it may be assumed that the prover 110 and the verifier 120 already share a secret key or use private-public keys pairs for sending messages encrypted. For instance, they can run an authentication protocol in advance.

According to an embodiment, it may be provided that the “challenger”, i.e. the verifier 120, for preventing attacks, includes a nonce for freshness into the challenge message sent to the prover 110. In this case, the response from the prover 110 may include the result of the request and, in addition, the nonce to relate the result to the request. The messages may also include components that identify the sender and recipient, like signing the messages and including an id of the recipient.

In addition to the prover 110 and the verifier 120, there is a third entity: the collector 130. The collector 130 obtains information about the application's execution from the prover 110. It aggregates this information and sends it to the verifier 120. In some embodiments, it is assumed that the collector 130 can sign messages, e.g., by having access to services of the machine's trusted computing base. This allows the verifier 120 to check the authenticity and integrity of messages it receives from the collector 130.

According to an embodiment, the collector 130 runs on the same machine as the prover 110. However, in contrast to the prover 110, the collector 130 is trusted. This can be achieved, e.g., by running the collector 130 as a trusted kernel module, in a trusted execution environment like an Intel SGX enclave or inside the TrustZone of ARM processors, or even inside a security monitor with highest privilege mode as Keystone for RISC-V CPUs (as described, e.g., in D. Lee, D. Kohlbrenner, S. Shinde, K. Asanović, and D. Song: “Keystone: An Open Framework for Architecting Trusted Execution Environments”, in Proceedings of the 15^{th} European Conference on Computer Systems (EuroSys), ACM Press, 2020, available online at https://doi.org/10.1145/3342195.3387532, which is hereby incorporated by reference herein).

Another important difference between the collector 130 and the prover 110 (and also the verifier 120) is that the collector 130 is independent from the application, which is executed by the prover 110 and which execution is attested by the verifier 120. More concretely, in a preprocessing step prior to program execution—which, in the context of the present disclosure is sometimes referred to as offline phase—the program may be instrumented for sending information about its execution to the collector 130. The verifier 120 may have a database of valid program executions. This database may be created also in the offline phase. Both the instrumentation and the database are program dependent. In a subsequent online phase, the prover 110 may execute the (instrumented) program and send information about its execution to the collector 130. The verifier 120 obtains measurements about an execution and checks their correctness by lookups in its database. According to embodiments, the measurements may be created by the collector 130 from the information that it receives from the prover 110. Alternatively, the verifier 120 can obtain the measurements directly from the collector 130. Details about the two phases are provided below.

As mentioned above, according to the underlying system model 100 the verifier 120 and the collector 130 are trusted, whereas the prover 120 is untrusted. In some embodiments of the present disclosure, the following assumptions about an attacker are made, which are identical to the ones in T. Abera et al.: “C-FLAT: Control-Flow Attestation for Embedded Systems Software”, in Proceedings of the 2016 ACM SIGSAC Conference on Computer and Communications Security (CCS), ACM Press, 2016 (which is hereby incorporated by reference herein) and which are also in line with previous works on remote attestation. Namely, while physical attacks are ruled out, an attacker is allowed to hijack the execution of the program code to be attested, as in return-oriented programming. Such attacks are based on providing malicious inputs to the prover 110. In some embodiments, data execution prevention (DEP) is assumed to prevent an attacker from injecting and executing malicious code into running processes, which is common on today's hardware platforms. In this regard, it is referred to, e.g., the write-xor-execute (W⊕X) policy according to which memory pages cannot be marked as both writeable and executable at the same time. Furthermore, in some embodiments, a trust anchor is assumed that allows, e.g., to take measurements of the static program and to generate fresh, authenticated attestation reports.

### Background

In some embodiments, the methods and systems disclosed herein make use of Control flow graphs ((FGs). CFGs are commonly used to optimize programs and analyze programs. They are, e.g., widely used in code optimization techniques during code compilation and in static analysis tools. In particular, most compilers build control flow graphs from the source code when building the executable. Control flow graphs can also be obtained from executables when analyzing binary code (for reference, see, e.g., D. Brumley, I. Jager, T. Avgerinos, E. J. Schwart: “BAP: A Binary Analysis Platform”, in Proceedings of the International Conference on Computer Aided Verification (CAV), Springer-Verlag, 2011, available online at https://doi.org/10.1007/978-3-642-22110-1_37 and X Meng and B.P. Miller: “Binary Code is not Easy”, in Proceedings of the 25^{th} International Symposium on Software Testing and Analysis (ISSTA), ACM Press, 2016, available online at https://doi.org/10.1145/2931037.2931047).

As it can be assumed to be general knowledge of a skilled person, a program's control flow graph (CFG) is a graph-based representation of all paths that might be traversed through a program during its execution. A node in the CFG corresponds to a basic block (BB), i.e., a straight-line code segment without any jumps or jump targets. The directed edges in the CFG represent the jumps in the control flow. In other words, a BB is a straight-line code sequence with no branches in except to the entry and no branches out except at the exit. In embodiments disclosed herein, it is assumed that the CFG has at least one entry point, i.e., a node from which an execution starts. It is also assumed that executions terminate in BBs that are leaves in the CFG, i.e., nodes without outgoing edges. It is noted that not all paths from an entry point to a leaf correspond to an actual execution, but any execution corresponds to a path in the CFG from the entry point to a leaf.

In the following, it is assumed that the program's CFG only contains nodes that are reachable from an entry point. CFG nodes that are not reachable from any entry point can be removed, since their corresponding BB is never executed. Furthermore, a single entry point is assumed. This is also without loss of generality, since for each entry point, it is likewise possible to consider the subgraph with the nodes reachable from the entry point and handle each subgraph separately.

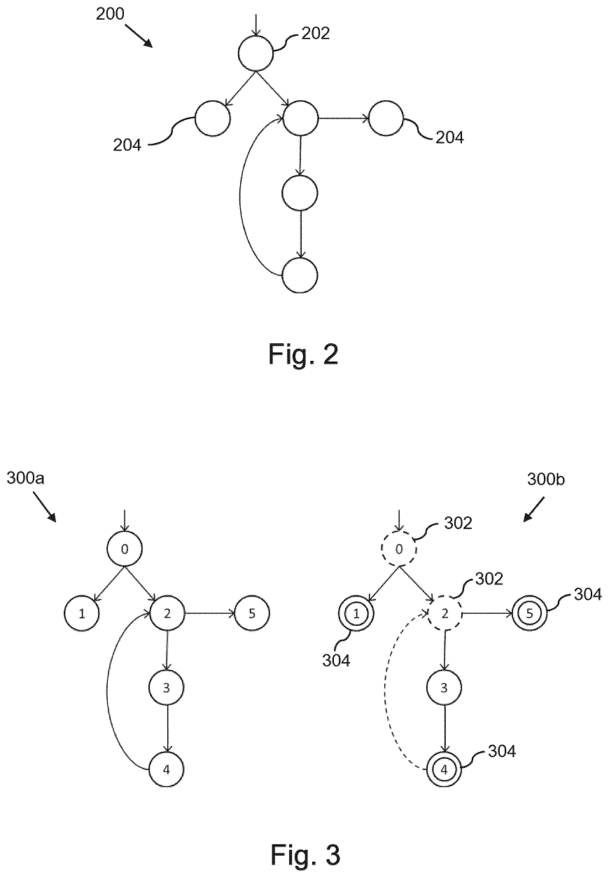

As a running toy example for illustration, the CFG 200 in FIG. 2 is considered. It should be noted that the graph 200 is finite and directed. Furthermore, it has an entry point 202 (the top most node) and leaves 204 (i.e., nodes without outgoing edges). It can also be observed that the graph 200 is not acyclic.

The CFG 200 shown in FIG. 2 could originate from the following program, where the nodes (BBs) correspond to labeled code lines. It should be noted that the BBs of a CFG often contain machine code instructions. For simplicity, C-like code is used in the running example, wherein other kind of code could be used likewise.

| | |
|---|---|
| | int secret_sum(int *seq, int len) { |
| | int i, v, s = 0; |
| L0: | if (!auth) { |
| L1: | return −1; |
| | } |
| L2: | for (i = 0; i < len; i++) { |
| L3: | v = decrypt(seq[i]); |
| L4: | s += v; |
| | } |
| L5: | return s; |
| | } |

It should be noted that for keeping the running example simple and small, implementation details about functions like decrypt in the code above and the CFG 200 shown in FIG. 2 are omitted here. It is assumed that such omitted details correspond to a single BB with a single CFG node. In practice, non-critical functions or program parts are also often merged into single CFG nodes, as their precise control flow in executions is irrelevant or considered as non-critical.

In the above example, the execution runs twice through the body of the for-loop consisting of the following program locations L0, L2, L3, L4, L2, L3, L4, L2, L5. It is noted that in this execution, the global Boolean variable auth is false and the argument len of the secret sum function is 2. The execution visits the corresponding nodes in the CFG from FIG. 2.

### Offline Phase

According to embodiments, the present disclosure provides a method for checking control flow attestation measurements, wherein the method comprises an offline phase that is configured to prepare a given program for attesting its executions. In particular, it may be provided that the offline phase is carried out prior to the deployment of the program and before program execution. On the prover 110 side, the program is instrumented to report its execution's steps to the collector 130 during its execution. That is, the prover 110 executes the instrumented program. On the verifier 120 side, a database with measurements of correct executions is populated. In the following, embodiments of the offline phase and its respective steps are described in detail.

CFG decomposition. According to an embodiment, a first step in the offline phase is to analyze the program based on its CFG. To this end, first, a unique identifier may be assigned to each node in the CFG. This can, e.g., be done by typological sorting. It is noted that the node labeling is not unique and depends on how the graph is traversed (e.g., by a depth-first search or a breadth-first search). This is shown in the graph 300a on the left-hand side of FIG. 3, where the identifiers are integers and match with the line numbers of the example program above.

Next, the graph 300a is decomposed into a directed acyclic graph (DAG). According to an embodiment, the DAG is obtained by removing edges that close loops (so-called back edges). It should be noted that the back edges are not uniquely determined, i.e., there can be multiple different sets of back edges to obtain an acyclic subgraph. The right-hand side of FIG. 3 shows such a DAG 300b obtained by removing the dashed edge. The right-hand side of FIG. 3 also shows the leaves 304 of the DAG 300b (as double circled nodes) and its roots 302 (as dashed circled nodes). A leaf 304 is a node with no outgoing edges. It is noted that the back edges are not part of the DAG 300b. A root 302 is either the CFG's 300b entry point or a destination node of a back edge.

According to an alternative embodiment, the CFG may be decomposed into a DAG by computing a so-called feedback vertex set (FVS) for directed graphs. Concretely, for the given CFG, first a FVS may be computed and, from the FVS, a DAG may be obtained by deleting the outgoing edges from the nodes in the FVS, i.e., all the outgoing edges from a node in the FVS are back edges. The nodes in the FVS are leaves in the DAG. Later, an alternative will be described that uses a so-called feedback arc set (FAS). Computing FVSs and FASs are well studied problems (for reference, see the links https://en.wikipedia.org/wiki/Feedback_vertex_set and https://en.wikipedia.org/wiki/Feedback_arc_set). It is noted that although the corresponding decision problems are NP-hard problems, there are approximation algorithms and heuristics to compute such sets and the proposed solution here does not require that the computed FVS (or FAS) is minimal. However, sets with fewer nodes (or fewer edges) are usually preferable.

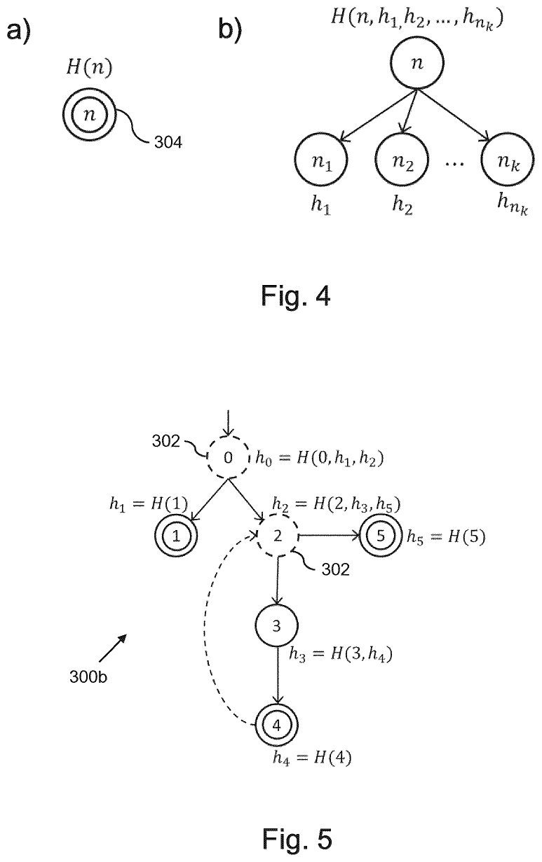

CFG annotation. According to an embodiment, the second step comprises CFG annotations. In this context, it may be provided that the nodes of the DAG 300b are annotated with hash values. This step may be done bottom-up, i.e. starting from the leaves 304. A leaf 304 may be annotated with the hash of its identifier. A non-leaf node may be annotated with the hash of its identifier and the hashes of its children. FIG. 4 illustrates this process in accordance with an embodiment of the present disclosure, where the base case (i.e. for leaves 304) is depicted on the left-hand side (FIG. 4a) and the step case (i.e. for non-leaves) is shown on the right-hand side (FIG. 4b).

FIG. 5 shows the hash annotations of the nodes of the CFG 300 for the running example. Here, a hash function H with arbitrary arity n>0 is assumed. When the nodes are unordered, the order of the arguments must not matter. This can easily be achieved, e.g., by ordering the hash values of the children ascendingly, assuming a linear order on the hash value domain. Recall that a (cryptographic) hash function maps its input to a unique value (with overwhelming probability). The values have a fixed size. Furthermore, the hash function is one-way, i.e., it is considered practically infeasible to invert or reverse the computation. Prominent instances of hash functions, which may be used in the context of the present disclosure, include, but not limited to, SHA-2, SHA-3, BLAKE2, and BLAKE3.

Verifier database. According to embodiments, the verifier's 120 database is populated with the hash annotations of the root nodes 302 of the DAG 300. It is noted that the size of the database is linear in the number of nodes. As can be obtained from FIG. 5, in the running example, the database consists of the two values h₀ and h₂.

Program instrumentation. According to embodiments, for obtaining information about the execution of the given program, the program is instrumented. That is, prior to executing the program, the program is modified to inform the collector 130 about the visited CFG nodes during an execution. It is important to point out that the added code must not change the execution path of the original program, i.e., the visited nodes in the CFG of an execution. Furthermore, the modifications must be done by a trusted entity, either before program deployment or at program load time, e.g., by a trusted boot loader. One can use static remote attestation methods to ensure that the correct program is executed.

First, for a visited node, the collector 130 may obtain from the prover 110 the unique identifier of the visited node. Obviously, with this information, the collector 130 can keep track of the control flow, i.e., the path of the visited nodes in the CFG 300. According to embodiments, the collector 130 may also obtain from the prover 110 the one or more of the following additional information items—denoted N1, N2, N3—for each visited node in the CFG 300 during program execution. Below, it will be described in detail how this additional information may be used by the collector 130 in an online phase.
(N1) A Boolean value indicating whether the visited node is a leaf 304 in the DAG 300b.
(N2) A list of the identifiers with the parents of the visited node for which the back edge has been deleted in the DAG 300b. Note that for a non-root node, this list is empty.
(N3) A list of hashes of a node's children nodes when exiting the node. The hash of the next visited node does not need to be included in this list.

It is noted that all this is static information and can be hardcoded into the instrumented program, e.g., in tables as key-value pairs that may be loaded by the collector 130 at program start to reduce the overhead during runtime, in particular, for the lists in (N2) and (N3).

The concrete modifications of the program depend on the underlying platform and architecture (in particular, the CPU and also the operating system). For instance, control may be passed to so-called trampolines on ARM CPUs, as described in T. Abera et al.: “C-FLAT: Control-Flow Attestation for Embedded Systems Software”, in Proceedings of the 2016 ACM SIGSAC Conference on Computer and Communications Security (CCS), ACM Press, 2016.

### Online Phase

In the online phase, the verifier 120 attests program executions of the prover 110 that runs the instrumented program obtained in the offline phase. Prior to program execution, the verifier 120 may—as is usually done—statically attest remotely that the intended program was correctly loaded into memory. It is assumed that those skilled in the art are sufficiently familiar with such static attestation of the instrumented program such that a detailed description of this process can be omitted here.

Before proceeding with the details of the online phase, first some intuition is given on computing the measurements for an execution. It is noted that this computation shares some similarities used in authenticated data structures (ADS) like Merkle trees (for reference, see R. Tamassia: “Authenticated Data Structures”, in Proceedings of the European Symposium on Algorithms (ESA), Springer-Verlag, 2003 and A. Miller, M. Hicks, J. Katz, and E. Shi: “Authenticated data structures, generically”, in Proceedings of the 41^{st} Symposium on Principles of Programming Languages (POPL), ACM Press, 2014, available online at https://doi.org/10.1145/2535838.2535851, which are hereby both incorporated by reference herein).

Reconsidering the execution of the running example that runs twice through the body of the for-loop, the corresponding path in the graph 300a on the left-hand side of FIG. 3 is 0→2→3→4→2→3→4→2→5, where the node identifiers are used to identify the visited nodes. According to an embodiment of the present disclosure, the path is chopped into segments. A segment is a subpath that is a path in the DAG 300b that starts at a root and ends in a leaf. Note that a node occurs at most once in a segment. In the running example, there are three segments, namely S₀=0→2→3→4, S₂=2→3→4, and S₃=2→5.

Suppose that for each node in a segment, one has the hash annotations of its children, except the hash annotation of the next visited node in the segment. For instance, for the segment S₀, one has the hash annotations h₁ for the first node 0 in S₀, h₅ for the second node 2 in S₀, and no hash annotations for the nodes 3 and 4. According to embodiments, it may be provided that, for the given annotations, a measurement Mᵢ is computed bottom-up, i.e., starting from the respective leaf. According to an embodiment, this computation can be executed as follows:
(1) For the leaf node 4 of the segment S₀, M₀ is computed as H(4), which equals the node's hash annotation h₄.
(2) For the node 3 of the segment S₀, M₁ is computed as H(3,H(4))=H(3,h₄)=h₃.
(3) For the node 2 of the segment S₀, M₂ is computed as H(2,H(3,H(4)),h5)=H(2,h₃,h₅)=h₂.
(4) Finally, for the root node 0 of the segment S₀, M₃ is computed as H(0,H(2,H(3,H(4))),h₁)=H(0,h₂,h₁)=h₀.

It should be recalled that the order of the arguments in H is irrelevant.

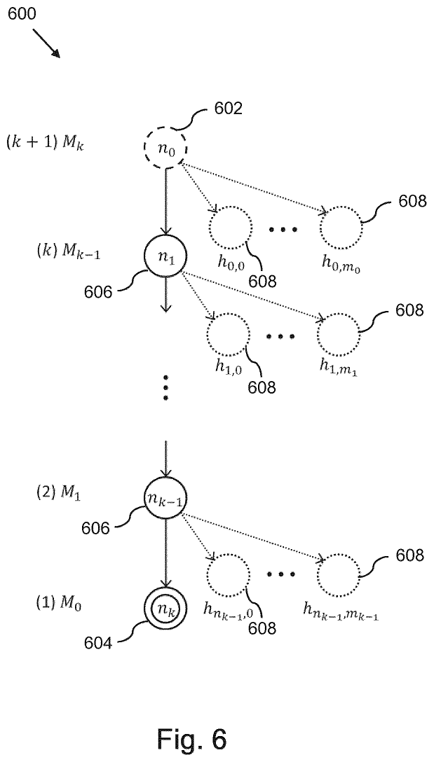

FIG. 6 illustrates an example of a measurement's bottom-up computation for a segment 600, where the dashed circle is the segment's root 602, the double-circled node is the segment's leaf 604, and the normally circled nodes are the other nodes 606 that are visited in the execution. Furthermore, the dotted circled nodes are the children nodes 608 of a visited node 606, excluding the next node that is visited in the execution.

According to embodiments of the present disclosure, the measurement M₀ for the segment's root 602 is sent to the verifier, e.g. verifier 120 shown in the system model 100 of FIG. 1, and checked. If the measurement M₀ occurs in the verifier's 120 database, the execution corresponds to a path in the CFG. However, according to embodiments, additional checks may be performed, which will be described further below.

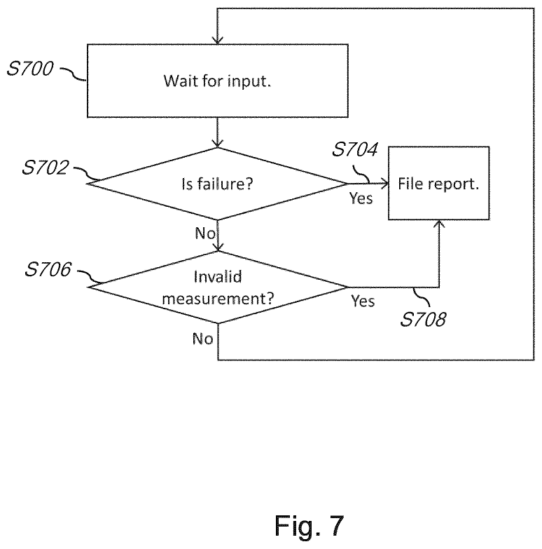

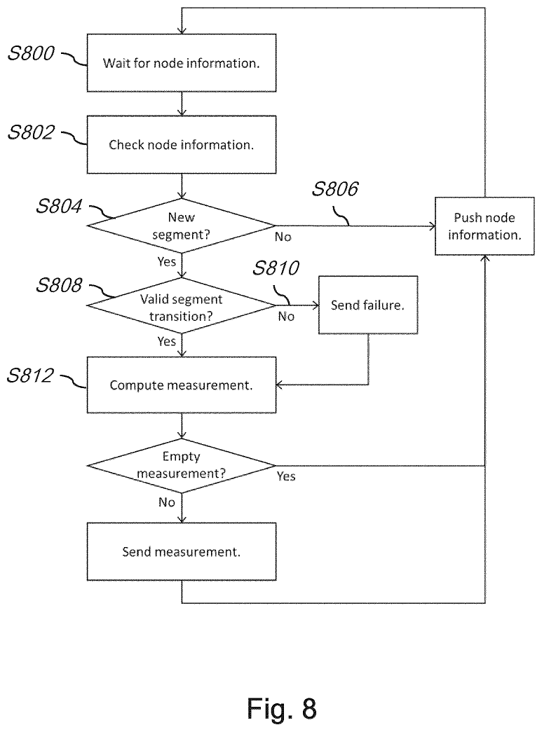

The prover, e.g. prover 110 shown in the system model 100 of FIG. 1, executes the instrumented program. It is noted that during program execution, information about the execution is sent to the collector 130. FIGS. 7 and 8 show an embodiment of the main loops executed by the verifier 120 and the collector 130, respectively.

As shown in FIG. 7, the verifier 120 continuously waits for input (S700). Upon receiving input, the verifier 120 authenticates the input and checks its integrity. For authentication and ensuring message integrity standard cryptographic methods can be used here. As shown at S702, the verifier 120 checks whether the input is a failure (situations, in which a failure is sent to the verifier 120, are described below in connection with FIG. 8) or a measurement. In case the input is a failure, the failure is reported to a file report collection, as shown at S704. When receiving a measurement, the verifier 120 checks whether the measurement is included in its database (see S706). If this is the case, it proceeds with processing the next input. Otherwise, it reports the invalid measurement to the file report collection, as shown at S708. A reported failure or a reported invalid measurement can, e.g., trigger the termination of the program or its restart.

As shown in FIG. 8, analogously to the verifier 120, the collector 130 also continuously waits for input (S800). According to an embodiment, each input received is processed according to the collector's 130 main loop shown in FIG. 8. The input, which is checked (S802) at the beginning of the main loop, consists of information about the visited nodes in the execution of the program and is received from the prover 110. The collector 130 may maintain a stack on which it collects the received node information.

According to an embodiment, it may be provided that the received node information is pushed to the stack (S806), if the respective node is not a node of a new segment (S804). Otherwise, e.g., because the previously received information is information of a leaf, the respective node is a root and belongs to a segment different from the segment of the nodes that are currently on the stack. It is noted that with the information (N1)—as defined above—the collector 130 is aware whether a node is a leaf.

According to an embodiment, it may be provided that the collector 130 first checks (S808) whether there is a valid transition from the node at the top of the stack and the newly received node. If the two nodes are not adjacent, a failure is reported (S810) to the verifier 120 because the two segments cannot be properly connected. With the information (N2) at hand, this check is straightforward for the collector 130.

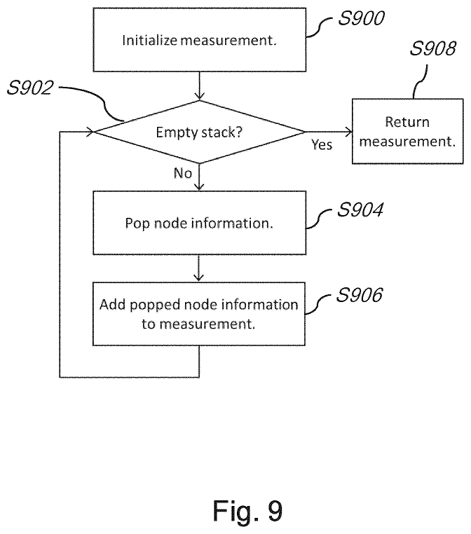

Afterwards, if a valid segment transition has been observed at S808, the collector 130 computes the measurement of the segment for the nodes that are stored on the stack, as illustrated at S812. According to an embodiment, this computation may be done according to the flow diagram shown in FIG. 9.

Accordingly, the collector 130 starts, as shown at S900, with initializing the measurement as an empty measurement and then checks whether the stack is empty or not, as shown at S902. As long as the stack is not empty, the collector 130 iteratively pops or retrieves the respective top element from the stack (S904) and combines it with the measurement computed so far (S906). If the stack is empty, the obtained measurement is returned, as shown at S908. According to an embodiment, an optimization of the computation may be implemented by caching previously computed measurements. For computing the measurement, the identifiers of the nodes are used and the hashes of a node's children. In this context, recall that by (N3) the collector 130 is aware of the hashes.

The collector 130 then sends the measurement to the verifier 120 and finally pushes the node information received in the respective loop iteration to the empty stack. It may be provided that the measurements are sent to the verifier 120 only after successful authentication of the verifier 120 towards the prover 110, e.g. after execution of a challenge-response authentication (as explained above). According to an embodiment, the collector 130 signs the measurement (possibly also including the nonce from a verifier's 120 challenge) to authenticate the measurement and to ensure its integrity (and freshness).

Batching. According to an embodiment, instead of sending the measurement of each segment separately to the verifier 120, the measurements can be send in batches. This can be more efficient in certain cases, in particular, when the segments are short.

Alternatively, or in addition, measurements of multiple segments can be combined into a single measurement. Concretely, the collector 130 may compute the hash H(M₀, . . . , Mₙ₋₁), for the single measurements M₀, . . . , Mₙ₋₁ (n>1) conducted for the segments S₀, . . . , Sₙ₋₁. It should be noted that the collector already checked that the segments are properly connected, as described above in connection with FIG. 8. However, it is also noted that in the offline phase, a combined measurement must have been included in the verifier's 120 database.

Caching. Another optimization for the collector 130 in accordance with an embodiment of the present disclosure is to reuse previously computed measurements of segments or suffixes of segments. Recall that the measurement of a segment is computed bottom-up from the leaf of the segment to the root of the segment, as described in connection with FIG. 9.

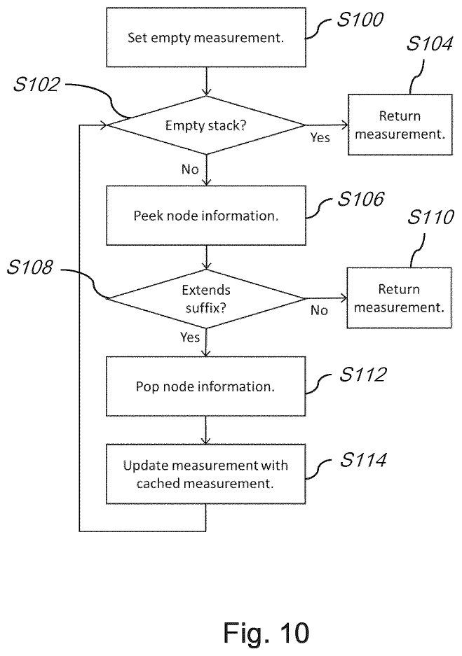

Instead of always initializing the measurement with the empty measurement (cf. step S900 of FIG. 9), the collector 130 may be configured to use a cache and to check whether a measurement for the nodes currently on the stack has already been computed. A respective embodiment is illustrated in FIG. 10. Generally, if no measurement is cached, then the empty measurement is returned. Otherwise, the nodes occurring in the segment suffix are popped or retrieved from the stack. It is pointed out that the check whether the cache contains a measurement of a suffix extended with the top stack element can be efficiently realized by using tries (aka digital trees or prefix trees), where a path in the trie corresponds to a segment suffix.

In the embodiment with cache extension, the collector 130 starts, like in the embodiment of FIG. 9 without cache extension and as shown at S100 in FIG. 10, with initializing the measurement as an empty measurement and then checks whether the stack is empty or not, as shown at S102. If the stack is empty, the obtained measurement is returned, as shown at S104. As long as the stack is not empty, the collector 130 iteratively peeks or checks node information from the nodes of the current segment, as shown at S106. If it is determined, at S108, that the segment suffix is not extended, the obtained measurement is returned, as shown at S110. Otherwise, the collector 130 pops or retrieves the respective top element from the stack (S112) and updates the measurement with the respective cached measurement (S114).

For illustration, the execution in the running example explained above is reconsidered, that is, the execution with the path 0→2→3→4→2→3→4→2→5 in the CFG. In this example, nothing is cached for computation of the first the segment S₀=0→2→3→4. The measurement for the second segment S₁=2→3→4 is cached and can be reused, instead of recomputing it again from scratch. If the body of the loop is executed more often (because len is larger than 2), the collector 130 may obtain the measurement for each loop iteration from the cache. Finally, no measurements are cached and reused for the third, final segment S₂=2→5.

If the measurement for the whole segment is cached (i.e., the stack is empty), it is not necessary to check the measurement by the verifier 120. The reason is that the verifier 120 has previously checked a measurement of a segment of which the current segment is a suffix. For example, this is the case for the segment S1 above, which is a suffix of the segment So and So has been previously checked. If the previous check passed, the suffix must correspond to a path in the CFG and no check is necessary for the suffix. Conversely, if the previous check did not pass, the check for the suffix may also not pass. However, in this case, the verifier already reported an invalid measurement. Depending on the use case, there may be no need to report another invalid measurement.

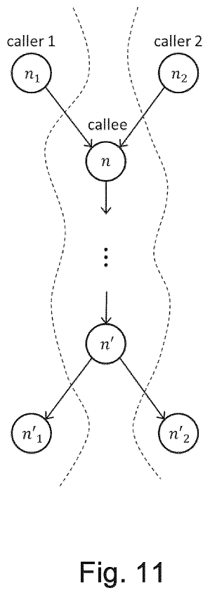

Calls and returns. According to embodiments that aim at improving the precision of the measurements, it may be provided that the collector 130 is configured to check whether the calls and returns match. FIG. 11 shows a part of a CFG where both the nodes n₁ and n₂ call a function with the entry point n. At node n′, the function returns to the caller n′₁ and n′₂, respectively. If just following the paths in the CFG, the called function can return to a node that is not the caller, e.g., the function is called from the node n₁ and returns to the node n′₂.

To exclude such paths that do not correspond to actual executions, in an embodiment, the collector 130 may be configured to maintain a second stack, sometimes denoted shadow stack herein, and check whether return addresses match with the call sites. To this end, in a call at the node nᵢ to a function at node n, the collector 130 may obtain additional information about the matching return node, namely, n′ᵢ. According to an embodiment, this information can also be provided as a table of matching call-return pairs to the collector 130 at program start. The collector 130 may be configured to push the identifier of the matching return node on its shadow stack. When returning to the caller, i.e., to node n′ᵢ from the function at node n′, the collector 130 checks whether the node identifier matches with the popped element. The collector 130 reports non-matching nodes as failures. Note that the nodes from the caller and the called function do not necessarily have to occur in the same segment; they can be visited in different segments.

Hashing Adjacent Segments. As described above, for two segments, where the first precedes the second one, the collector 130 checks whether there is a valid transition from the last node of the first segment to the first node of the second segment. In this context, it is referred to FIG. 8, which includes such a validity check when starting a new segment. For carrying out this check, the prover 110 provides the additional information (N2) to the collector 130. In the following, an alternative solution is described that ensures that two segments are properly connected. An advantage of this alternative solution is that it does not require the information (N2) from the prover 110. Instead, the verifier 120 checks whether two consecutive segments are properly connected. To this end, the collector 130 may be configured to compute additional hashes and the verifier's 120 database must be populated in the offline phase with slightly different measurements.

In the online phase, the collector 130 keeps track of the last node of the previous segment in the execution. Initially, the collector 130 sets this value to some null or invalid node (e.g., −1 when the nodes in the CGF are labeled by integers from 0 onwards), marking the beginning of an execution. When starting a new segment, the collector 130 computes—as before—the measurement of the completed segment S. Additionally, the collector 130 computes the hash H (m, h), where m is the node that is newly stored by the collector 130 and h is the computed measurement for S. Intuitively, H(m, h) represents the fact that the segment S was entered from the node m by an edge to the first node n of S. Note that m is a leaf and n is a root. Finally, the collector 130 sends H(m, h), which is checked by the verifier 120, and updates m, i.e., the collector 130 sets m to the last node in S.

The verifier's 120 database is setup accordingly in the offline phase. Namely, in the offline phase, the verifier's 120 database is not populated with measurements of all segments from the CFG. Instead, the verifier's 120 database is populated with measurements that additionally include the entry points to segments, i.e., the hashes H(m, hₙ), where m is a leaf with an edge to a root n with the hash hₙ. Intuitively speaking, such a measurement ensures that a segment was properly entered, namely, from the node m to the node n. For the first segment in an execution, the null node is used for m, as mentioned above, for marking the beginning of an execution. As before (cf. FIG. 7), in the online phase, the verifier 120 checks the received measurements against the measurements in the verifier's 120 database.

Feedback Arc Sets. According to the embodiments described above, the CFG (cf. graph 300a of FIG. 3) is decomposed into a DAG (cf. graph 300b of FIG. 3) by computing a so-called feedback vertex set (FVS); more precisely, the outgoing edges of the nodes are removed in the computed FVS nodes. These nodes are then leaves in the resulting DAG. According to an alternative embodiment, instead of removing all the outgoing edges of certain nodes, it may be provided that individual edges are removed to remove cycles. That is, a so-called feedback arc set (FAS) is computed for the given CGF. Removing individual edges in the CFG to obtain a DAG can result in longer segments and hence fewer measurements. In the following, the changes when using a FAS instead of a FVS are described.

The key difference is that the end of a segment in an execution is not anymore caused by visiting a leaf, if it is not the end of the execution, but by following an edge in the FAS. Hence, it may be provided that instead of information item (N1), the collector 130 obtains from the prover 110 an amended information item (denoted N1′) whether the new node n was entered by following a back edge from the previous node m in the CFG. This is again static information about the CFG that can be hardcoded into the instrumented program as a table. For example, the collector 130 can obtain this table at the beginning of the online phase.

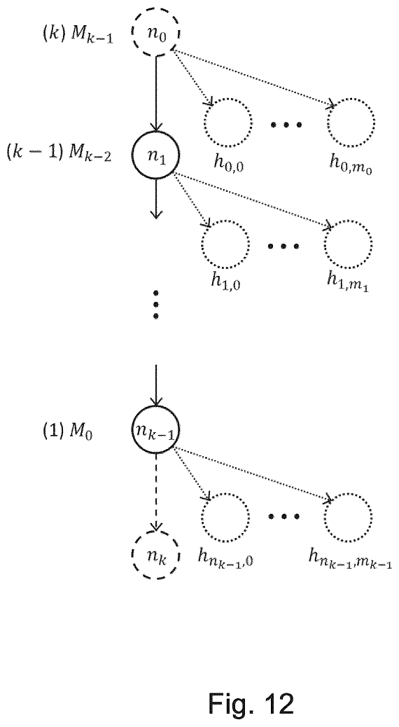

It is pointed out that the collector's 130 main loop, as explained above in connection with FIG. 8, can remain unchanged. The computation of the measurement for a segment may again be performed bottom-up, e.g., as described above in connection with FIG. 9. However, in contrast to the computation described above when using FVS (which is illustrated in FIG. 6), when using FAS, the segment's last node may have children and their hashes must be included in the measurement. This bottom-up measurement computation when segments end by following a back edge instead of ending always in a leaf is illustrated in the diagram of FIG. 12.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention or disclosure is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method of performing control flow attestation, the method comprising:
constructing a control flow graph, (CFG) of a program whose execution by a prover is to be attested;
decomposing the CFG into a directed acyclic subgraph (DAG);
annotating nodes of the DAG bottom-up with hashes and installing the hashes of root nodes of the nodes of the DAG at a measurement database of a verifier;
receiving, by a collector during program execution, information from the prover about the nodes of the DAG along the program execution, the information including the hashes of the nodes; and
generating, by the collector, program execution measurements by computing, based on the information received from the prover, for each execution segment of the DAG, the hash of the corresponding root node of the execution segment and sending the generated program execution measurements including the computed hashes of the root nodes to the verifier.

2. The method according to claim 1, further comprising:
checking, by the verifier, a correctness of the received hashes of the root nodes based on the hashes of the root nodes installed at the measurement database of the verifier.

3. The method according to claim 1, further comprising:
in an offline phase that is carried out prior to the program execution, modifying the program by providing the program with the hashes of the nodes of the DAG and instrumenting the program to communicate, whenever one of the nodes is entered, the hash of the respective node to the collector.

4. The method according to claim 3, wherein the program modifications are performed by a trusted entity either before program deployment or at program load time.

5. The method according to claim 3, wherein the program instrumentation is performed in such a way that the collector obtains from the prover a unique identifier of each visited node and at least one of the following additional information items:
a Boolean value indicative of whether the visited node is a leaf node in the DAG,
a list of the identifiers with parents of the visited node for which a back edge has been deleted in the DAG,
a list of hashes of children nodes of the visited node when exiting the visited node.

6. The method according to claim 2, further comprising:
executing, by the verifier prior to program execution, a static remote attestation method to ensure that an instrumented program has been correctly loaded into a memory of a machine of the prover.

7. The method according to claim 1, wherein the collector is run as a trusted kernel module of a machine of the prover.

8. The method according to claim 1, wherein the CFG is decomposed into the DAG by computing a feedback vertex, set (FVS) and by removing outgoing edges of the nodes in the computed FVS, or
wherein the CFG is decomposed into the DAG by computing a feedback arc set (FAS) and by removing individual edges of the nodes in the computed FAS.

9. The method according to claim 1, wherein the program execution measurements are handed over to the verifier in batches.

10. The method according to claim 1, further comprising:
combining program execution measurements computed for two or more execution segments of the DAG into a single program execution measurement.

11. The method according to claim 2, wherein the step of checking, by the verifier, the correctness of the received hashes of the root nodes based on the hashes of the root nodes installed at the measurement database of the verifier is performed instantly based on program execution measurements handed over to the verifier during program execution or as a post processing step after the program execution based on logged program execution measurements.

12. The method according to claim 1, further comprising:
caching previous measurements of the execution segments; and
reusing, by the collector, measurements of the execution segments or suffixes of the execution segments from the cache.

13. An apparatus for performing control flow attestation, the apparatus comprising one or more processors configured, alone or in combination, to facilitate execution of the following steps:
a) constructing a control flow graph (CFG) of a program whose execution by a prover is to be attested;
b) decomposing the CFG into a directed acyclic subgraph (DAG);
c) annotating nodes of the DAG bottom-up with hashes and providing the hashes of root nodes of the nodes of the DAG for installation at a database of a verifier;
d) receiving, during program execution, information from the prover about the nodes of the DAG along the program execution, the information including the hashes of the nodes; and
e) generating program execution measurements by computing, based on the information received from the prover, for each execution segment of the DAG the hash of the corresponding root node of the execution segment and sending the generated program execution measurements comprising the computed hashes of the root nodes to the verifier.

14. The apparatus according to claim 13, wherein steps d) and e) are executed by a collector that is run as a trusted kernel module of a machine of the prover.

15. A tangible, non-transitory computer-readable medium having instructions thereon, which, upon execution by one or more processors, perform control flow attestation by providing for execution of the following steps:
a) constructing a control flow graph (CFG) of a program whose execution by a prover is to be attested;
b) decomposing the CFG into a directed acyclic subgraph (DAG);
c) annotating nodes of the DAG bottom-up with hashes and providing the hashes of root nodes of the nodes of the DAG for installation at a database of a verifier;
d) receiving, during program execution, information from the prover about the nodes of the DAG along the program execution, the information including the hashes of the nodes; and
e) generating program execution measurements by computing, based on the information received from the prover, for each execution segment of the DAG the hash of the corresponding root node of the execution segment and sending the generated program execution measurements comprising the computed hashes of the root nodes to the verifier.
